(19) United States
(12) Patent Application Publication
(10) Pub. No.: US 2026/0053094 A1
(43) Pub. Date: Feb. 26, 2026

(54) Attachment For an Agricultural Harvester and an Agricultural Harvester

(71) Applicant: CLAAS Saulgau GmbH, 88348 Bad Saulgau (DE)

(72) Inventors: Christian König, Oberteuringen (DE); Sebastian Blender, Herdwangen-Schönach (DE)

(21) Appl. No.: 19/219,818

(22) Filed: May 27, 2025

(30) Foreign Application Priority Data
May 28, 2024 (DE) 102024114966.3

(51) Int. Cl. A01D 69/03; A01D 61/00; F15B 15/14; F15B 15/24

(52) U.S. Cl. CPC A01D 69/03; A01D 61/008; F15B 15/1428; F15B 15/24

(57) ABSTRACT

Attachment (10) for an agricultural harvester, with a main frame (11) designed to connect the attachment (10) to the agricultural harvester, with a crop conveyor (12), which is attached to the main frame (11) via brackets (15) in such a way that the crop conveyor (12) is mounted rotatably on the brackets (15) and is pivotable together with the brackets (15) in relation to the main frame (11), wherein the crop conveyor (12) is designed, in conjunction with a floor plate (14), to convey the crops. At least one hydraulic cylinder (18) acts directly or indirectly on the main frame (11) and on at least one bracket (15) or on an auxiliary frame (19) connected to the brackets (15), which hydraulic cylinder is designed to push or pull the crop conveyor (12) in the direction of the floor plate. The respective hydraulic cylinder (18) has a cylinder (20), a first piston (21) displaceable in the cylinder (20) and a further piston (35) which is likewise displaceable in the cylinder (20) and is designed to limit the movement of the first piston (21) and thus the movement of the crop conveyor (12) in the direction of the floor plate (14). FIG. 1

The invention relates to an attachment for an agricultural harvester and to an agricultural harvester having an attachment.

DE 10 2012 011 574 B4 discloses an attachment in the form of a pick-up apparatus for an agricultural harvester. The pick-up apparatus has a main frame designed to connect the pick-up apparatus to the agricultural harvester. In addition, the pick-up apparatus comprises a crop collector and a crop conveyor. The crop collector is attached to the main frame and is designed to pick up the crops from a ground surface. The crop conveyor is fastened pivotably to the main frame via brackets, wherein the crop conveyor is designed, in conjunction with a floor plate, to convey the crops picked up by the crop collector.

DE 198 47 891 A1 discloses another attachment in the form of a pick-up apparatus for an agricultural harvester with a crop collector and a crop conveyor.

It is known from practice to lift or raise the crop conveyor of such a pick-up apparatus by means of at least one single-acting hydraulic cylinder against the spring force of at least one spring element, that is to say to move it away from the floor plate. The at least one spring element pulls or pushes the crop conveyor in the direction of the floor plate under a preload between the crop conveyor and the floor plate. The spring force of the at least one spring element counteracts the lifting or raising of the crop conveyor, as a result of which the permissible spring force of the spring element and thus preload between the crop conveyor and the floor plate is limited.

Against this background, the present invention is based on the object of creating a novel attachment for an agricultural harvester and an agricultural harvester having such an attachment.

This object is achieved by an attachment according to Claim 1 and by an agricultural harvester according to Claim 11.

According to the invention, at least one hydraulic cylinder acts directly or indirectly on the main frame and on at least one bracket or on an auxiliary frame connected to the brackets, which hydraulic cylinder is designed to push or pull the crop conveyor in the direction of the floor plate.

The respective hydraulic cylinder has a cylinder, a first piston displaceable in the cylinder and a further piston which is likewise displaceable in the cylinder and is designed to limit the movement of the first piston and thus the movement of the crop conveyor in the direction of the floor plate.

By means of the further piston, which is displaceable in the cylinder, the movement of the first piston and thus the movement of the crop conveyor in the direction of the floor plate can be limited. The invention ensures this with a simple design.

The respective hydraulic cylinder is preferably a double-acting hydraulic cylinder, which is designed, on the one hand, to push or to pull the crop conveyor in the direction of the floor plate and, on the other hand, to move the crop conveyor away from the floor plate. This embodiment is particularly preferred in order not only to use the respective hydraulic cylinder to move the crop conveyor in the direction of the floor plate, but also to move the crop conveyor away from the floor plate and thus, if necessary, to lift or raise the crop conveyor. Double-acting hydraulic cylinders make this possible with a simple design of the attachment.

Preferably, a hydraulic chamber is formed in each case on both sides of the respective first piston, wherein, when a first hydraulic chamber is filled with hydraulic oil, the crop conveyor is pushed or pulled in the direction of the floor plate, and wherein, when a second hydraulic chamber of the respective first piston is filled with hydraulic oil, the crop conveyor is moved away from the floor plate.

The further piston delimits the second hydraulic chamber and a third hydraulic chamber wherein a hydraulic pressure prevailing in the third hydraulic chamber determines the position of the further piston and thus the volume in the first hydraulic chamber. In this way, it is possible in a particularly simple manner to limit the movement of the crop conveyor in the direction of the floor plate in a flexible and thus adjustable manner.

The attachment is preferably in the form of a pick-up apparatus which furthermore has a crop collector, which is attached directly or indirectly to the main frame, wherein the crop collector is designed to pick up crop from a ground surface, and wherein the crop conveyor is designed to convey the crop picked up by the crop collector. The invention is preferably used in pick-up apparatuses which, in addition to the crop conveyor, also have a crop collector.

In a further preferred embodiment, the attachment is designed as a cutting mechanism which furthermore has a mowing device, which is attached to the main frame and is designed to sever or cut crop from a field floor and to transfer the severed or cut crop to the crop conveyor, which is designed to convey the crop transversely to a harvesting direction.

The agricultural harvester is preferably designed as a self-propelled forage harvester.

Preferred developments of the invention can be gathered from the dependent claims and from the following description. Exemplary embodiments of the invention are explained in more detail on the basis of the drawing, without being limited thereto. In the drawing:

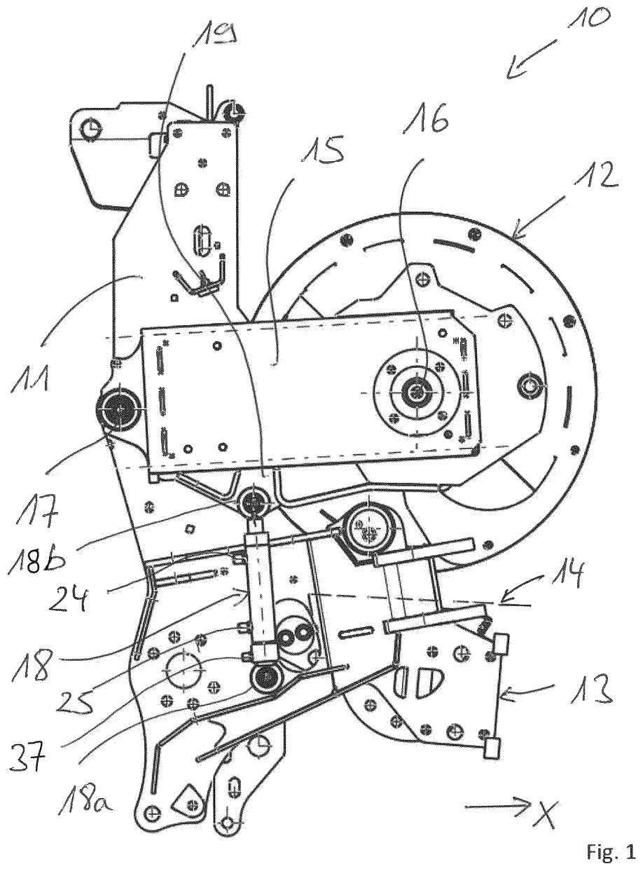

FIG. 1 shows a side view of a detail of an attachment in the form of a pick-up apparatus for an agricultural harvester,

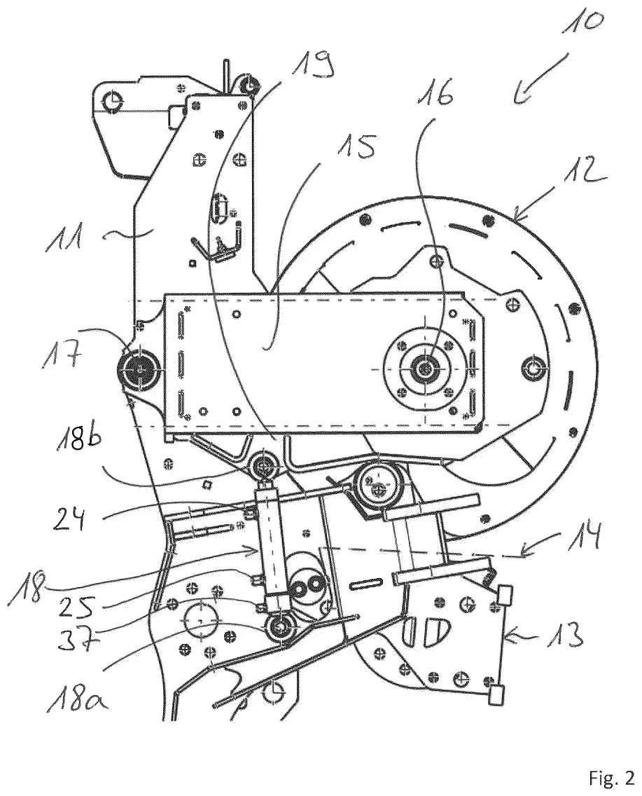

FIG. 2 shows the detail of FIG. 1 in another state;

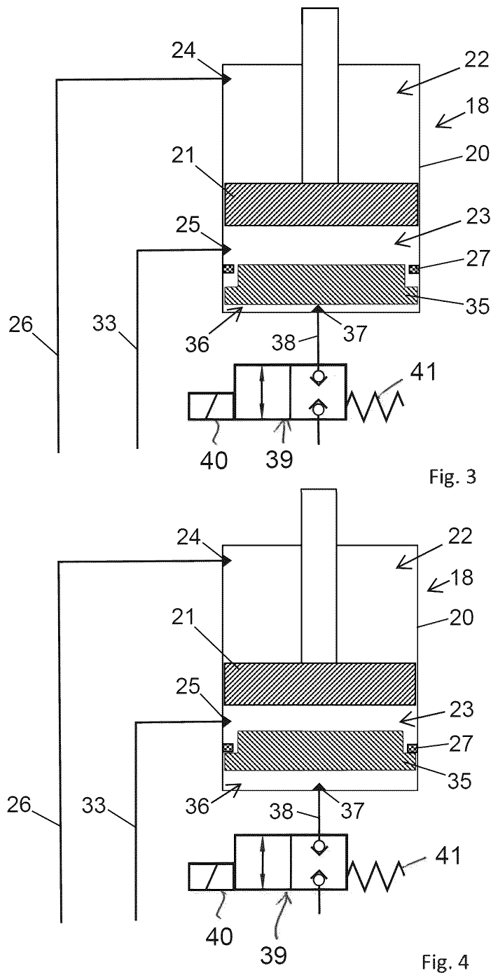

FIG. 3 shows a section from a hydraulic diagram of the attachment of FIGS. 1 and 2 in a first state of the hydraulic cylinder,

FIG. 4 shows the hydraulic diagram of FIGS. 1 and 2 in a second state of the hydraulic cylinder.

FIGS. 1 and 2 each show a side view of an attachment 10 which is in the form of a crop pick-up apparatus for an agricultural harvester.

The attachment 10 has a main frame 11 designed to connect the attachment 10 to an agricultural harvester, in particular to a self-propelled forage harvester. The attachment 10 has a crop collector, not shown in FIG. 1, and a crop conveyor 12, shown in FIG. 1. The crop collector, not shown in FIG. 1, is mounted below the crop conveyor 12 on a mounting flange 13 of the main frame 11.

The crop collector is designed to pick up crop from a ground surface. The crop preferably lies on the ground in the form of what is referred to as swath, which was formed in a preceding working step during mowing of the crop or after mowing. The crop conveyor 12 serving to convey the crop picked up by the crop collector, not shown, interacts with a floor plate 14. The floor plate 14 is arranged on the crop collector, not shown, and forms a conveying floor for the crop conveyor 12.

For transporting the crop, the crop conveyor 12 is pushed or pulled in the direction of the floor plate 14. FIGS. 1 and 2 differ here in terms of the distance between the crop conveyor 12 and the floor plate 14. In FIG. 1, the distance between the crop conveyor 12 and the floor plate 14 is increased in comparison to FIG. 2.

The crop conveyor 12 is mounted rotatably on brackets 15 and is pivotably attached to the main frame 11 via the brackets 15. FIGS. 1 and 2 show an axis of rotation 16, about which the crop conveyor 12 is mounted rotatably on the brackets 15. Such a bracket 15 is arranged at each of the two lateral ends of the crop conveyor 12.

Furthermore, FIGS. 1 and 2 show a pivot axis 17, about which the brackets 15 and, via the brackets 15, the crop conveyor 12 are pivotable relative to the main frame 11, in particular in order to set the distance between the crop conveyor 12 and the floor plate 14.

As already explained, the floor plate 14 is arranged in a transfer region between the crop collector, not shown in FIGS. 1 and 2, and the crop conveyor 12, shown in FIGS. 1 and 2. The floor plate 14 is positioned below the crop conveyor 12.

The crop conveyor 12, which is designed in particular as a cross auger, conveys the crop, in conjunction with the floor plate 14, to a central region of the attachment 10, where it is passed on to the harvester.

During operation, the attachment 10 is moved by the agricultural harvester in the direction of travel X, wherein, as viewed in this direction of travel X, the floor plate 14 is arranged behind the crop collector, not shown.

In order now to pull or to push the crop conveyor 12 in the direction of the floor plate, the attachment 10 has at least one hydraulic cylinder 18, which is fastened by way of a first end 18a in an articulated manner directly or indirectly to the main frame 11 and by way of an opposite second end 18b in an articulated manner to a bracket 15 or to an auxiliary frame 19, which is in particular fixedly connected to the bracket 15.

Preferably, a hydraulic cylinder 18 of this type is provided on both sides of the crop conveyor 12, which hydraulic cylinder engages in an articulated manner or is mounted in an articulated manner on the one hand directly or indirectly on the main frame 11 and on the other hand on in each case one of the brackets 15 or on the auxiliary frame 19 on both sides of the crop conveyor 12.

In the exemplary embodiment shown, the respective hydraulic cylinder 18 is in the form of a double-acting hydraulic cylinder. The latter is designed, on the one hand, to push or pull the crop conveyor 12 in the direction of the floor plate 14 and, on the other hand, to move the crop conveyor 12 away from the floor plate 14, specifically in order to lift or raise the crop conveyor 12.

Accordingly, by means of the at least one double-acting hydraulic cylinder 18, the distance between the crop conveyor 12 and the floor plate 14 can be changed. Thus, by means of the at least one double-acting hydraulic cylinder 18, on the one hand, the crop conveyor 12 can be pushed or pulled, and, on the other hand, the crop conveyor 12 can be moved away from the floor plate 14 and thus lifted or raised in order to increase the distance from the floor plate 14.

In a raised position, conveyed crop blockages that have occurred or drawn-in foreign bodies can be eliminated particularly advantageously in a simple manner.

FIGS. 3 and 4 show a section from a hydraulic diagram of the attachment 10 with a hydraulic cylinder 18 preferably in the form of a double-acting hydraulic cylinder 18.

The hydraulic cylinder 18 has a cylinder 20 and a first piston 21, which is displaceable in the cylinder 20. A respective hydraulic chamber 22, 23 is formed on both sides of the piston 21, wherein a respective hydraulic connector 24, 25 of the hydraulic cylinder 18 interacts with each of the hydraulic chambers 22, 23.

When a first hydraulic chamber 22 is filled with hydraulic oil via the hydraulic connector 24 and a first hydraulic line 26 and hydraulic oil is discharged from a second hydraulic chamber 23 via the hydraulic connector 25 and a second hydraulic line 33, the crop conveyor 12 is pushed or pulled in the direction of the floor plate 14.

When the second hydraulic chamber 23 is filled with hydraulic oil via the hydraulic connector 25 and the second hydraulic line 33 and hydraulic oil is discharged from the first hydraulic chamber 22 via the hydraulic connector 24 and the first hydraulic line 26, the crop conveyor 12 is moved away from the floor plate 14.

The hydraulic cylinder 18, which is in the form of a double-acting hydraulic cylinder in the exemplary embodiment shown, has, in addition to the cylinder 20 and the first piston 21, which is displaceable in the cylinder 20, a further piston 35, which is likewise displaceable in the cylinder 20.

This displaceable further piston 35 can be transferred between the first, lowered position shown in FIG. 3 and the second, raised position shown in FIG. 4. By means of this further piston 35, the movement of the first piston 21 and thus the movement of the crop conveyor 12 in the direction of the floor plate 14 is limited.

According to FIGS. 3 and 4, the further piston 35, which is displaceable in the cylinder 20, delimits, on the one hand, the second hydraulic chamber 23 and, on the other hand, a third hydraulic chamber 36, which is connected via a third hydraulic connector 37 and a third hydraulic line 38 to a hydraulic pump, again not shown.

Incorporated into said third hydraulic line 38 is a switchable valve 39 which, in the switching position shown in FIGS. 3 and 4, has a blocking effect and separates the third hydraulic connector 37 and thus the third hydraulic chamber 36 from the respective hydraulic pump. From the blocking position of the valve 39 shown in FIGS. 3 and 4, said valve is displaceable via an actuator 40 counter to the spring force of a spring element 41 into a passage position in order to couple the third hydraulic chamber 36 to the respective hydraulic pump.

In the state of the further piston 35 shown in FIG. 3, the latter is retracted further into the cylinder 20 in the direction of a base thereof in comparison to the state of FIG. 4 such that the first piston 21 in FIG. 3 can be retracted further into the cylinder 20 in comparison to FIG. 4, in order in this way ultimately to move the crop conveyor 12 further in the direction of the floor plate 14.

In FIG. 4, in comparison to FIG. 3, the position of the further piston 35 is displaced further in the direction of a cover of the cylinder 20 lying opposite the base, as a result of which, in comparison to FIG. 3, the first piston 21 can be retracted less far into the cylinder 20, as a result of which, in comparison to FIG. 3, a greater distance is then set between the crop conveyor 12 and the floor plate 14.

By means of the further piston 35, which is displaceable in the cylinder 20 of the hydraulic cylinder 18, the distance between the floor plate 14 and the crop conveyor 12 can be set when the crop conveyor 12 is pulled or pushed in the direction of the floor plate 14 via the respective hydraulic cylinder 18.

The movement of the further piston 35 within the cylinder 20 is limited by a stop 27 between the positions, shown in FIGS. 3 and 4, of the further piston 35. The stop 27 for the further piston 35 is mounted or fastened in a fixed position on an inner wall of the cylinder 20. The stop 27 for the further piston 35 engages in a recess in the further piston 35 and limits the displaceability thereof within the cylinder 20.

Instead of a stop 27, other means for limiting the travel of the further piston 35 can also be provided. Said means have to be designed such that, on the one hand, they limit the travel of the further piston 35, but at the same time do not impede the movement of the first piston 21, in particular if its complete stroke travel is released by the further piston 35.

If the further piston 35 assumes the position shown in FIG. 4, in which the further piston 35 limits the retraction of the first piston 21 into the cylinder 20 further than in FIG. 3, a hydraulic pressure is set within the third hydraulic chamber 36, which hydraulic pressure prevents that, as a result of the first piston 21 being retracted into the cylinder 20 and the pressure brought about as a result in the second hydraulic chamber 23, the further piston 35 is pushed out of the position shown in FIG. 4 in the direction of the position shown in FIG. 3.

A pressure sensor, which is preferably arranged in the hydraulic line 38, can be provided for monitoring the pressure in the third hydraulic chamber 36. The pressure sensor is preferably connected in terms of signaling to a control unit, and the control unit is designed, in the event of a drop in the pressure below a predefined value, to activate the valve 39 in such a way that the pressure rises to a required value.

With the invention, the minimum distance between the crop conveyor 12 and the floor plate 14 can be set when the respective hydraulic cylinder 18 pulls or pushes the crop conveyor 12 in the direction of the floor plate 14.

If a greater distance between the crop conveyor 12 and the floor plate 14 is desired, the further piston 35 of the hydraulic cylinder 18 assumes the position shown in FIG. 4. If, on the other hand, a smaller distance between the crop conveyor 12 and the floor plate 14 is desired, the further piston 35 assumes the position shown in FIG. 3.

If the attachment 10 is operated with hydraulic cylinders 18 in which the respective further pistons 35 assume the position shown in FIG. 4, i.e. in which a relatively large distance is desired between the crop conveyor 12 and the floor plate 14 for transporting the picked-up crop, and if the attachment 10 or the agricultural harvester carrying the attachment is operated in a headland position, the further piston 35 can be automatically transferred from the state shown in FIG. 4 into the state shown in FIG. 3, in order to reduce the distance between the crop conveyor 12 and the floor plate 14 in the headland such that the floor plate 14 is cleared of the crop.

The further piston 35 can be automatically transferred between the positions shown in FIGS. 3 and 4, which serve to set a different distance between the crop conveyor 12 and the floor plate 14, by means of a control unit; it is also possible that this transfer is triggered by a driver of the agricultural harvester by actuation of a button or switch in the cab of the agricultural harvester.

To detect whether the attachment 10 is in a raised headland position, the control unit can receive signals from the harvester, in particular from a self-propelled forage harvester. The signals indicate to the control unit whether the attachment 10 is in a raised headland position or in an operating position. The control unit can process the signals and generate corresponding control signals for the valve 39.

A further automatic function can set the position of the further piston 35 on the basis of further parameters, such as, for example, depending on the throughput quantity of the crop through the attachment 10, which can be detected, for example, by means of pressure sensors or else by means of a camera.

Furthermore, the screw height of the crop conveyor 12 can also alternatively or additionally be controlled depending on a driving force which is required for driving the attachment 10 or depending on a crop mat height which is fed to the harvester, in particular to a forage harvester. For this purpose, the control unit can also process signals relating to a hydraulic pressure in a hydraulic line for a hydraulic drive of the attachment 10 or signals of a harvester for the crop mat height.

The automatic functions can significantly increase the use of the self-propelled forage harvester.

### LIST OF REFERENCE SIGNS

10 Attachment
11 Main frame
12 Crop conveyor
13 Mounting flange
14 Floor plate
15 Bracket
16 Axis of rotation
17 Pivot axis
18 Hydraulic cylinder
18a End
18b End
19 Auxiliary frame
20 Cylinder
21 Piston
22 Hydraulic chamber
23 Hydraulic chamber
24 Hydraulic connector
25 Hydraulic connector
26 Hydraulic line
27 Stop
33 Hydraulic line
35 Piston
36 Hydraulic chamber
37 Hydraulic connector
38 Hydraulic line
39 Valve
40 Actuator
41 Spring element

1. Attachment (10) for an agricultural harvester,
with a main frame (11) designed to connect the attachment (10) to the agricultural harvester,
with a crop conveyor (12), which is attached to the main frame (11) via brackets (15) in such a way that the crop conveyor (12) is mounted rotatably on the brackets (15) and is pivotable together with the brackets (15) in relation to the main frame (11), wherein the crop conveyor (12) is designed, in conjunction with a floor plate (14), to convey the crops,
characterized in that
at least one hydraulic cylinder (18) acts directly or indirectly on the main frame (11) and on at least one bracket (15) or on an auxiliary frame (19) connected to the brackets (15),
which hydraulic cylinder is designed to push or pull the crop conveyor (12) in the direction of the floor plate (14),
the respective hydraulic cylinder (18) has a cylinder (20), a first piston (21) displaceable in the cylinder (20) and a further piston (35) which is likewise displaceable in the cylinder (20)
and is designed to limit the movement of the first piston (21) and thus the movement of the crop conveyor (12) in the direction of the floor plate (14).

2. Attachment (10) according to claim 1, characterized in that
the respective hydraulic cylinder (18) is a double-acting hydraulic cylinder (18),
the respective double-acting hydraulic cylinder (18) is designed, on the one hand, to push or to pull the crop conveyor (12) in the direction of the floor plate (14) and, on the other hand, to move or lift the crop conveyor (12) away from the floor plate (14).

3. Attachment (10) according to either of claims 1 and 2, characterized in that
a hydraulic chamber (22, 23) is formed in each case on both sides of the respective first piston (21),
when a first hydraulic chamber (22) of the respective first piston (21) is filled with hydraulic oil, the crop conveyor (12) is pushed or pulled in the direction of the floor plate (14),
the further piston (35) delimits a second hydraulic chamber (23) of the respective piston (21).

4. Attachment (10) according to claim 3, characterized in that
when the second hydraulic chamber (23) of the respective first piston (21) is filled with hydraulic oil, the crop conveyor (12) is moved away from the floor plate (14).

5. Attachment (10) according to claim 3 or 4, characterized in that
the further piston (35) delimits the second hydraulic chamber (23) and a third hydraulic chamber (36),
a hydraulic pressure prevailing in the third hydraulic chamber (36) determines the position of the further piston (35) in the cylinder (20).

6. Attachment (10) according to claim 5, characterized in that
the third hydraulic chamber (36) is coupled to a hydraulic pump via a third hydraulic line (38), wherein a switchable valve (39) is arranged in the third hydraulic line (38), which valve, in a first position, connects the hydraulic pump to the third hydraulic chamber (36) and which valve, in a second position, disconnects the hydraulic pump from the third hydraulic chamber (36).

7. Attachment (10) according to any one of claims 1 to 6, characterized in that
said attachment is a pick-up apparatus which has a crop collector, which is attached directly or indirectly to the main frame (11), wherein the crop collector is designed to pick up crop from a ground surface, and wherein the crop conveyor (12) is designed to convey the crop picked up by the crop collector.

8. Attachment (10) according to any one of claims 1 to 6, characterized in that the attachment (10) is designed as a cutting mechanism which furthermore has a mowing device, which is attached to the main frame (11) and is designed to sever or cut crop from a field floor and to transfer the severed or cut crop to the crop conveyor (12), which is designed to convey the crop transversely to a harvesting direction.

9. Attachment (10) according to any one of the preceding claims, characterized in that a hydraulic cylinder (18) in each case acts directly or indirectly on the main frame (11) and on the respective bracket (15) or on the auxiliary frame (19) on both sides of the crop conveyor (12).

10. Agricultural harvester, in particular self-propelled forage harvester, having an attachment (10) according to one of claims 1 to 9.
